(19) United States
(12) Patent Application Publication
(10) Pub. No.: US 2007/0214718 A1
(43) Pub. Date: Sep. 20, 2007

(54) Plant pot

(76) Inventor: Hong Ku Park, Huntsville, AL (US)

Correspondence Address: LANIER FORD SHAVER & PAYNE P.C., P O BOX 2087, HUNTSVILLE, AL, 35804, US

(21) Appl. No.: 11/375,501

(22) Filed: Mar. 14, 2006

(51) Int. Cl. A01G 9/02

(52) U.S. Cl. 47/79

(57) ABSTRACT

An improved plant pot is claimed in which a pot suitable for use as a hanging plant or on a flat surface contains improved moisture control features. The moisture control features consist of a water level control system recessed into the bottom of the plant pot. When the water level in the pot exceeds a predetermined level, excess water can drain from the threaded spout on the bottom of the pot. A cap is provided that will cap off the flow of water or slow the flow of water, as desired by the user. The pot is convertible from a wall-hanging pot to a tabletop pot to a hook-hanging pot in various configurations.

### FIELD OF THE INVENTION

The present invention relates generally to a plant pot, and more particularly to a pot suitable for wall-hanging or tabletop use with features for maintaining the proper moisture in the plant.

### BACKGROUND OF THE INVENTION

Many potted plants are very sensitive to the moisture level in their pots. Some orchids, for example, require moist soil, but not wet soil. Typical plant pots with drainage holes in the bottom serve the purpose of draining excess water from the pots, but have the disadvantage that the only moisture remaining in the pot after watering is that retained by the soil. If a plant pot does not have drainage holes, however, the standing water in the pot can damage the plant. An improved plant pot would permit some water to remain in the bottom of the pot to be gradually absorbed by the soil after watering, but would drain off excess water. The plant plot disclosed in U.S. Pat. No. 6,672,003, contains such moisture control features. In this prior art invention, illustrated in FIG. 1, a water level control device drains off water above a predetermined level through a threaded spout that can be capped off. The disadvantage of this prior art invention is that its protruding bottom spout limits it to display by hanging, for example, on a wall.

Unlike the invention of U.S. Pat. No. 6,672,003, the plant pot of the present invention is also suitable for tabletop use. The moisture control features of the pot are recessed into the pot's bottom so that the bottom surface is flat. Therefore, the pot can be displayed on any flat surface. The pot also has a wall hanger for optional wall display.

Further, the water level control features have been simplified over those in the prior art invention. In the present invention, the water level control feature is molded into the pot, while in the prior art invention, the water control device was a separate piece that had to be inserted into the pot. The present invention is thus a simpler, sleeker, design.

It would also be desirable to be able to leave plants unattended for longer periods of time. With the present invention, a user can fill the plant pot with water, and leave the drain cap of the water level control device loosened so that water drips out slowly over time, leaving the plant's soil moist for longer than if the plant is simply watered once and the water is allowed to drain away.

### SUMMARY OF THE INVENTION

It is an object of the present invention to provide an improved plant pot that can either be hung on a wall or hook or placed on a flat surface without using special tools.

It is another object of the present invention to provide an improved plant pot that controls the water level in the pot and keeps suitable moisture in the pot.

It is a further object of the present invention to provide a water level control device that is integral to the pot.

It is a further object of the present invention to provide an improved plant pot with a bottom opening that allows excess water to be capped off completely or adjustably drained through by slightly loosening the cap.

It is a further object of the present invention to provide a means for securing the roots of the plant to the pot to stabilize the plant such that the securing mechanism is simple and does not protrude above the soil level (i.e., is not visible).

It is yet a further object of the present invention to provide an improved plant pot that is simple and inexpensive in construction and that may be easily used at home or in other environments for growing and displaying plants.

The plant pot of the present invention achieves these objectives by providing a container for holding a plant and soil, in which the container has a water level control device that is recessed into the bottom of the pot, so that the pot can sit level on a flat surface. The water level control device allows a predetermined amount of water to remain in the pot at all times to be gradually absorbed into the soil as moisture as needed. Water in excess of the predetermined amount can drain from openings in the water level control device. A cap is provided for capping off and/or controlling the flow of excess water.

The pot also includes a wall hanger so that the pot can be hung on a wall. The wall hanger can be folded up when the pot is to be displayed on a wall and folded down for a sleeker appearance when the pot is to be displayed on a flat surface.

The pot also has a means for stabilizing the roots of the plant and/or training the direction of a stem by connection of the roots to wires attached the water level control device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### DESCRIPTION OF THE DRAWINGS

FIG. 1 illustrates the prior art plant pot disclosed in U.S. Pat. No. 6,672,003.

FIG. 2 is a front perspective view of one embodiment of the invention.

FIG. 3 is a top view of one embodiment of the invention.

FIG. 4 is a partial sectional view of one embodiment of the invention.

FIG. 5 is an exploded partial view of the water level control portion of the invention.

FIG. 6 is a rear view of one embodiment of the invention illustrating the wall hanger.

FIG. 7 is a perspective view of the plant securement device of one embodiment of the invention.

FIG. 8 is a perspective view of a plant in the plant pot being secured by the plant securement device of one embodiment of the invention.

FIG. 9 is illustrates an optional plant hanging device available in some embodiments of the invention.

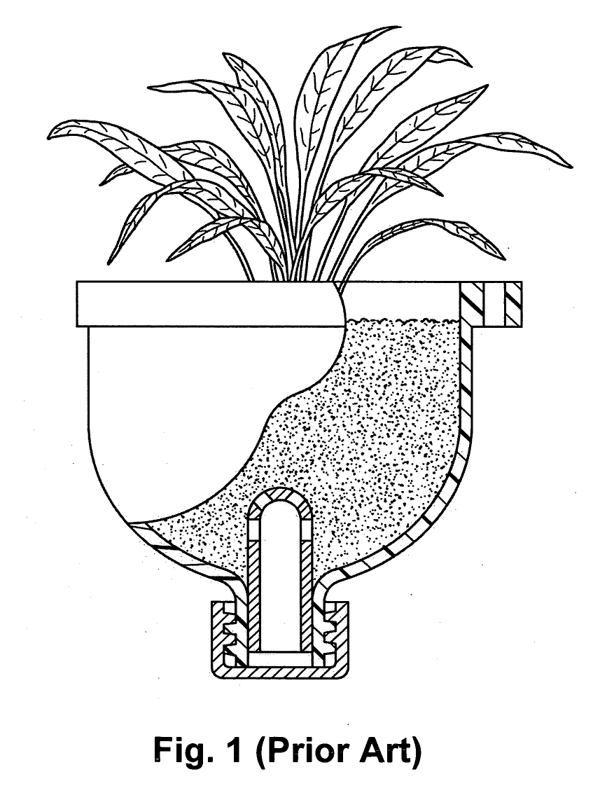

Repeat use of reference characters throughout the present specification and appended drawings is intended to represent the same or analogous features or elements of the invention.

### DETAILED DESCRIPTION

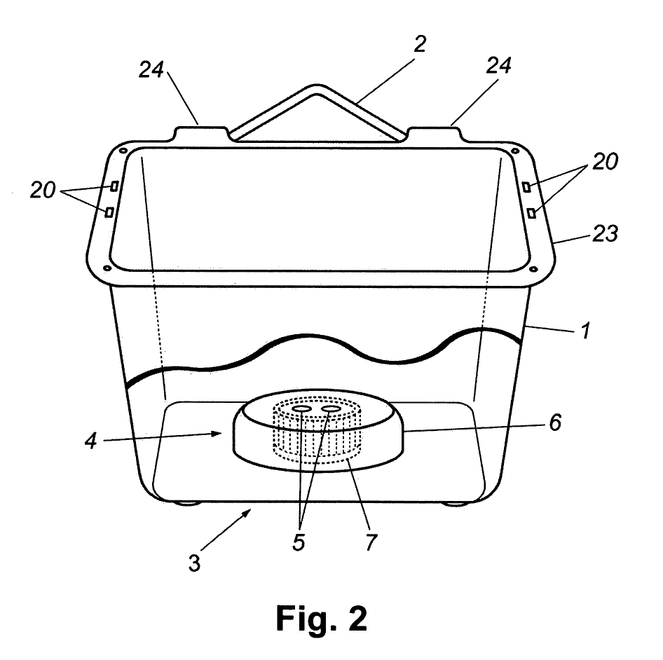

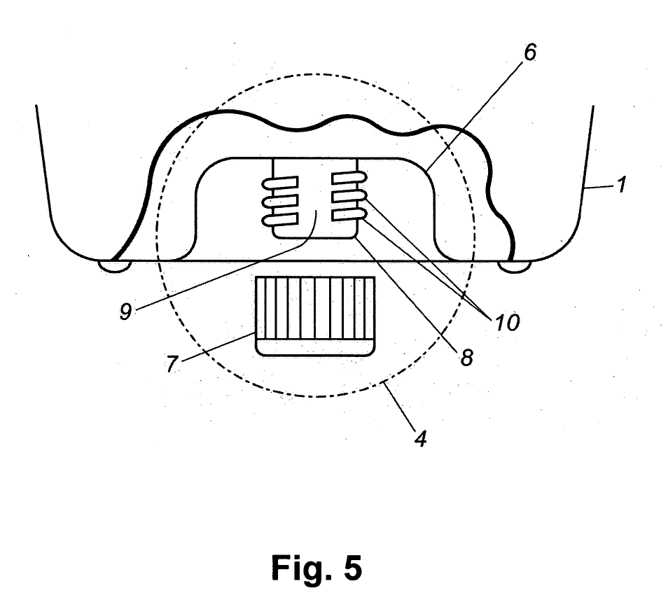

FIG. 2 illustrates one embodiment of the present invention. In this embodiment, the plant pot 1 contains a wall hanger 2 and a flat bottom portion 3 with a water level control device 4 recessed up into the bottom 3 of the pot 1. The water level control device 4 consists of a recess 6, the depth of which (“d”, as shown in FIG. 4) determines how much water remains in the bottom of the pot 1 following watering of the plant, to be gradually absorbed into the soil. The depth of the recess can be varied in different embodiments according to the moisture needs of various types of plants. The recession of the water level control device 4 leaves the bottom surface of the pot level (i.e., with no protrusions) to enable display of the pot on any flat surface.

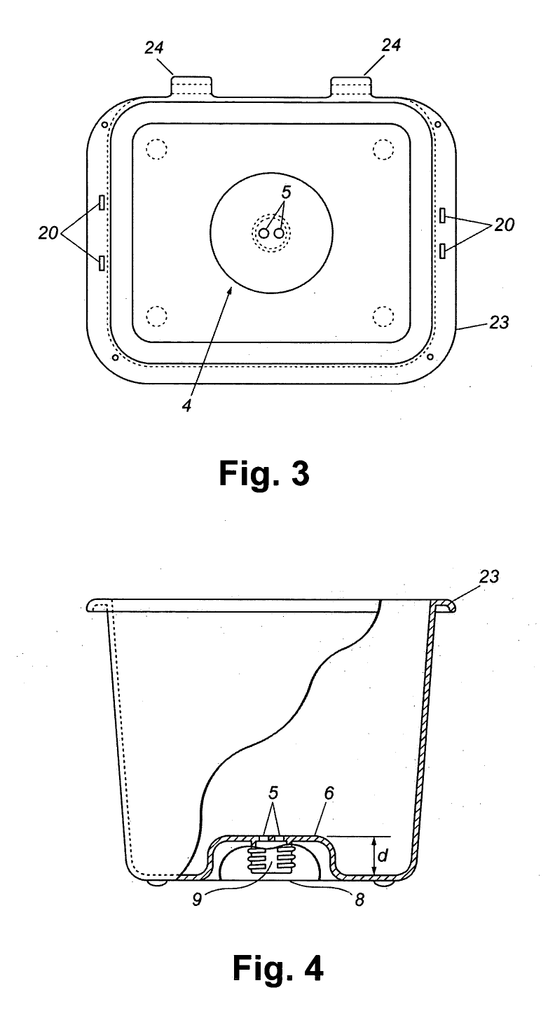

The top surface of the recess 6 contains one or more openings 5 through which water can drain from the pot 1 when the water level in the pot rises to the openings 5 (i.e., when the water level exceeds a depth of “d”). The openings 5 are also illustrated in FIG. 3, a top view of the plant pot. Although the embodiment of the invention shown in FIG. 3 has two circular openings 5, the openings could be any shape and size that permits water to drain from the pot while retaining the soil.

The water level control device 4 also contains a spout 8 with external threads, shown in FIG. 4, which directs the flow of water through the openings 5 away from the pot 1. The spout 8 can be connected to a standard water hose (not illustrated) for directing the water flow to a drain, over a porch rail, outdoors, etc. A channel 9 is longitudinally disposed through the threads of the spout 8.

Further, the water level control device 4 includes a cap 7 that screws onto threaded spout 8, as illustrated in FIG. 5, a partial exploded view of the water level control device 4. If the cap 7 is screwed tightly onto the spout 8, then the spout 8 is completely capped off, and no water can drain from the pot 1. If the cap is loosened, however, water can pass through channel 9 in the threads 10 of the threaded spout 8 and drain slowly from the pot. The flow of water from the pot 1 can thus be adjusted by adjusting the tightness of the cap 7 on the spout 8.

Note that the recess is sufficiently wide to allow a user's fingers to enter the recess 6 to tighten and loosen cap 7. Threaded spout 8 can be attached to a hose (not illustrated) for directing the water flow away from the pot and to a container, sink, over the porch rail, etc.

The plant pot 1 may be fabricated from any number of water-retaining rigid or semi-rigid materials, such as plastic, resin or composite material. Although the illustrated embodiments of the invention are rectangular pots, other shapes, such as cylindrical, are possible without departing from the scope of the present invention.

In operation, when a plant in the plant pot 1 is watered, the water level in the pot 1 will rise unimpeded until it the water reaches the level of depth “d,” as illustrated in FIG. 4. Thereafter, if the cap 7 is off or sufficiently loosened, the water will drain through openings 5 and out threaded spout 8. If the cap 7 is closed completely, then the water will be prevented from exiting the pot and the water level may increase above the level of depth “d.” If the cap is loosened slightly, then the water will drain from the pot slowly from the pot. By controlling the tightness of the cap 7 on the spout 8, a user may control the speed that the water drains from the pot 1.

Further, in some embodiments of the invention, channel 9 in the threaded spout 8 improves the drainage of the water from the spout 8 by allowing the water to easily and gradually drain from the pot without clogging, and enabling greater controllability of the water flow than if there were no channel in the threaded spout 8.

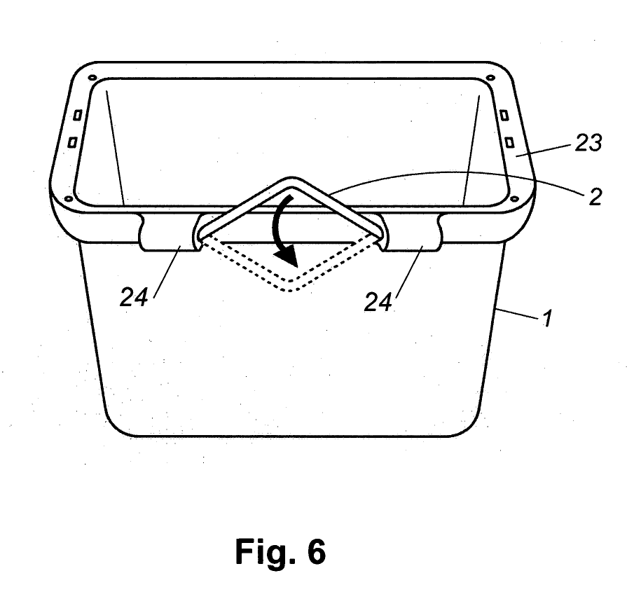

As is illustrated in FIG. 6, a wall hanger 2 is also included on some embodiments of the invention so that the plant pot 1 may be hung on a wall in via a screw or nail or other attachment device as an alternative to display on a flat surface. The wall hanger 2 fitted into protrusions 24 in the rim 23 of the pot and can be rotated approximately 180 degrees downward so as to be unobtrusive when the plant is displayed on a flat surface. Other means for connecting a wall hanger to the pot are possible without departing from the scope of the present invention.

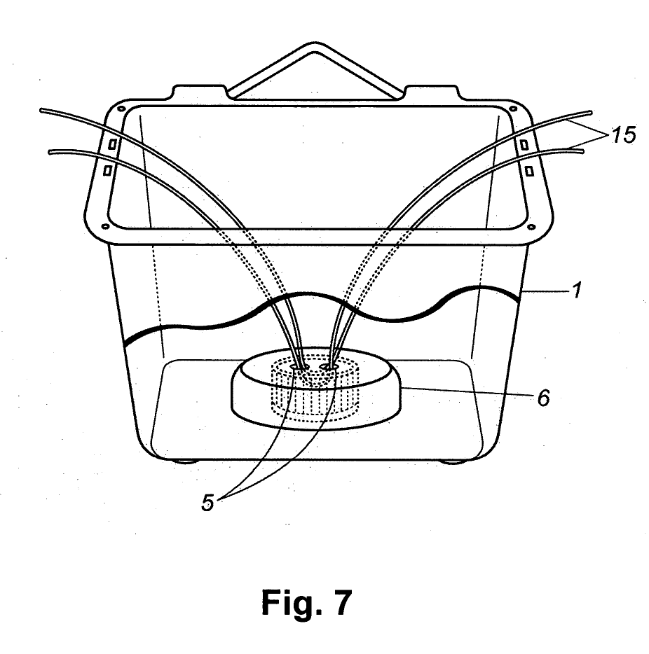

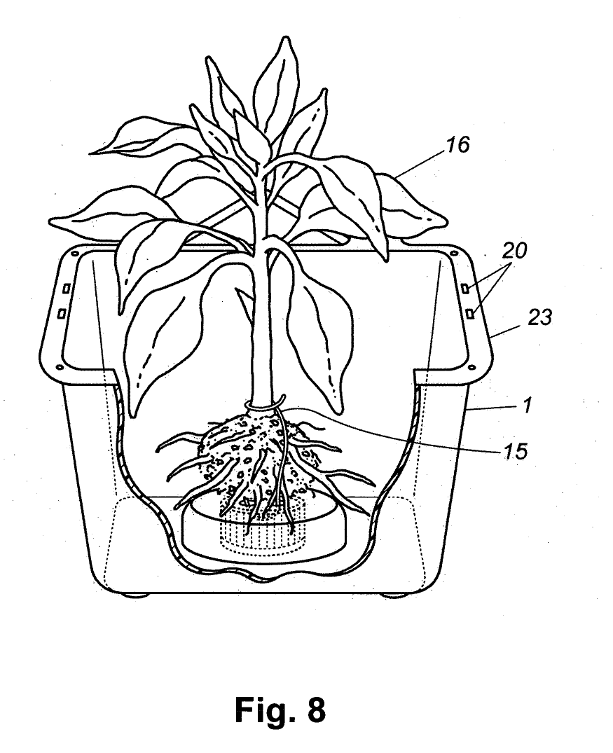

The invention also includes the capability to add plant securement features in some embodiments. Specifically, as illustrated in FIG. 7, restraint(s) 15 can be inserted through the openings 5 in the recess 6 of the pot 1. After a plant 16 is placed in the pot 1, the restraint 15 is secured to the plant, as illustrated in FIG. 8. The restraint 15 may consist of a cord or wire or any similar flexible or semi-flexible material securely anchored in or between the openings. The addition of restraints to the pot will not cause the pot to leak, other than the purposeful dripping by loosening the cap. After the plant 16 is secured, the pot 1 can be filled with soil. This type of plant securement system has the advantage that the restraint 15 is minimally visible above the surface of the soil, if it is visible at all. In addition to securely holding the plant within pot—which is especially desirable for plants that will be moved across distances or plants that may be top-heavy—the restraints 15 also may be used to give support to stems or vines that might be taller or in danger of breaking away from the plant. The plant securement features can also be used to train branches of a plant by restraining them in a desired position. This could be useful with plants such as ivy, orchids, vine roses, topiarys, and bonsai plants, for example. As is illustrated in FIG. 7, multiple restraints may be used in a single plant pot.

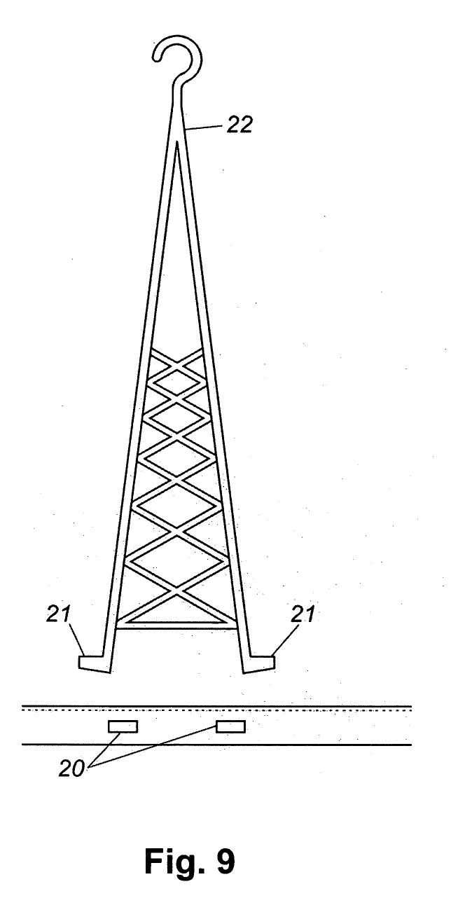

The plant pot 1 is compatible with other types of hanging devices as well. For example, slots 20 in the rim 23 of the pot 1, illustrated in FIG. 2, can be used with the hanger 22 of the type illustrated in FIG. 9, in which hanger's bottom protrusions 21 are inserted in the slots 20. With this plant hanging configuration, one hanger 22 would be inserted on each side of the rim 23. Then the two hangers 22 can be hung over a cord or on two hooks or the hangers 22 can be secured together and hung over one hook or other attachment device. Other hanging configurations are also achievable without departing from the scope of the invention.

As described above and shown in the associated drawings, the present invention comprises an improved plant pot. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A plant pot adapted to control the amount of moisture therein, comprising:
a container having a rimmed opening and a bottom,
a recess in the bottom extending into the container having
a top portion with one or more openings therein,
a spout for directing flow of excess water, the spout extending generally downwardly from the top portion and in fluid communication with the openings and having a threaded outer surface; and
a cap for controlling the flow of excess water, the cap having a threaded interior surface for mating with the threaded outer surface of the spout.

2. The plant pot of claim 1, wherein the threaded outer surface further comprises a channel disposed generally longitudinally with respect to the spout.

3. The plant pot of claim 1, further comprising a wall-hanging support device rotatably connected to the rim.

4. The plant pot of claim 1, wherein the rim further comprises a plurality of openings for insertion of ceiling hanging devices.

5. The plant pot of claim 1, wherein the depth of the recess exceeds the depth of the spout.

6. The plant pot of claim 1, further comprising at least one strap for securing a plant within the pot.

7. The plant pot of claim 6, wherein the at least one strap is threaded through the one or more openings in the top portion of the water level control device to secure the strap to the pot.

8. A plant pot adapted to control the amount of moisture therein, comprising:
a container having a rimmed opening and a bottom, the bottom comprising a cylindrical recess, the top portion of the cylindrical recess comprising a plurality of openings;
a spout for directing flow of excess water, the spout extending generally downwardly from the top portion and in fluid communication with the openings and having a threaded outer surface; and
a cap for controlling the flow of excess water, the cap having a threaded interior surface for mating with the threaded outer surface.

9. The plant pot of claim 8, wherein the depth of the cylindrical recess exceeds the depth of the spout.

10. The plant pot of claim 8, further comprising a wall-hanging support device rotatably connected to the rim.

11. The plant pot of claim 8, wherein the rim further comprises a plurality of openings for insertion of ceiling hanging devices.

12. The plant pot of claim 8, wherein the threaded outer surface further comprises a channel disposed generally longitudinally with respect to the spout.

13. The plant pot of claim 8, further comprising at least one strap for securing a plant within the pot.

14. The plant pot of claim 13, wherein the at least one strap is threaded through the plurality of openings in the top portion of the cylindrical recess to secure the strap to the pot.
